(19) United States
(12) Patent Application Publication
(10) Pub. No.: US 2012/0294027 A1
(43) Pub. Date: Nov. 22, 2012

(54) Universal Light Module for Exterior Side Rear View Mirror of Vehicle

(75) Inventor: Brian R. Merriman, Webster Groves, MO (US)

(73) Assignee: Code 3, Inc., St. Louis, MO (US)

(21) Appl. No.: 13/473,389

(22) Filed: May 16, 2012

Related U.S. Application Data
(60) Provisional application No. 61/486,900, filed on May 17, 2011.

(51) Int. Cl. B60R 1/08; H01R 43/00; F21S 8/10

(52) U.S. Cl. 362/519; 362/543; 29/854

(57) ABSTRACT

A light module for a side mounted rear view mirror of a vehicle includes a light and an electrical conductor for connecting the light to a power source through an opening to be formed in a forward facing surface of the rear view mirror housing. The module includes a boot having an opening at a front end and a flexible back end. A fastening system is adapted for mounting the light and boot on the forward facing surface of the rear view mirror housing so the flexible back end of the boot is compressed against the forward facing surface of the mirror housing and a segment of the electrical conductor extending from the opening in the forward facing surface of the rear view mirror housing is substantially enclosed in the boot when the light module is installed on the rear view mirror.

### FIELD OF INVENTION

The present invention relates generally to signal lighting for police cars and other vehicles and more particularly to methods and apparatus for providing signal lighting on an exterior side rear view mirror of a vehicle.

### BACKGROUND

Signal lighting has been used on vehicles for many years. For example, police cars and ambulances often have signal lights contained in light bars mounted on their tops. The signal lights are activated to indicate the vehicle is responding to an urgent call and alert other drivers of their obligation to avoid obstructing the vehicle while it is en route to high priority official business. When the vehicle has arrived on scene, the signal lighting may be activated or allowed to remain active in order to communicate the need for other people to be alert to the possibility of danger or unusual activity. For example, when a police officer makes a traffic stop the signal lighting can alert other drivers to this activity and the possibility that a police officer and other people may be outside their vehicles on or near the roadway. Signal lighting can also be used by road maintenance vehicles, motorist assist vehicles, construction vehicles, and the like to alert other people to a potentially hazardous or unusual condition.

Over the years efforts have been made to improve the effectiveness of signal lighting by increasing the likelihood that the signal lighting will be seen by those in the area. Thus, rather than rely on signal lighting from a light bar on top of the vehicle, auxiliary lighting systems can be included on the vehicle to increase visibility of the signal lighting. For example, U.S. Pat. No. 5,938,322 discloses a system for mounting a forward facing warning light on the exterior rear view mirrors mounted on the side doors of a vehicle. The '322 patent contemplates different light modules will be needed for different makes and models of vehicles and discloses a method of constructing a different metal mold for each of the various rear view mirror styles for which a light module will be used. The mold is constructed using modeling clay to create a false front in which a forward facing light is recessed. The '322 patent explains it is important to make the false front for each mirror match the contour of the original mirror to make the signal light inconspicuous until it is activated.

### SUMMARY

One aspect of the invention is a light module for an exterior side mounted rear view mirror assembly of a vehicle. The rear view mirror assembly is of a type that includes a mirror and a housing. The housing has an open end and a forward facing surface generally opposite the open end. The mirror is secured to the housing so a reflective surface of the mirror is visible from outside the housing. The light module includes a light and an electrical conductor electrically connected to the light and adapted for connecting the light to a power source through an opening to be formed in the forward facing surface of the rear view mirror housing before installation of the light module thereon is complete. The module includes a boot having an opening at a front end and a flexible back end. A fastening system is adapted for mounting the light and boot on the forward facing surface of the rear view mirror housing so the flexible back end of the boot is compressed against the forward facing surface of the mirror housing and a segment of the electrical conductor extending from the opening in the forward facing surface of the rear view mirror housing is substantially enclosed in the boot when the light module is installed on the rear view mirror.

Another aspect of the invention is a light module for an exterior side rear view mirror assembly of a vehicle. The rear view mirror assembly is of a type that includes a mirror and a housing. The housing has an open end and a forward facing surface generally opposite the open end. The mirror is secured to the housing so a reflective surface of the mirror is visible from outside the housing. The light module includes a light. A flexible boot has a front opening and a back end opposite the front opening. A fastening system is adapted for mounting the light source and boot on the forward facing surface of the rear view mirror housing. The fastening system and boot are operable to cause the back end of the boot to conform to any of a plurality of differently shaped forward facing mirror housing surfaces to facilitate installation of the light module on any of a plurality of different vehicle makes and models.

Yet another aspect of the invention is an exterior side rear view mirror assembly for a vehicle. The assembly has housing having an open rear end and a forward facing surface opposite the opening. A mirror is secured to the housing so a reflective surface of the mirror is visible from outside the housing. A boot has a front opening and a flexible back end. The flexible back end of the boot is compressed and sealed against the forward facing surface of the mirror housing. The back end of the boot is configured so at least a portion of the forward facing surface of the mirror housing is not covered by the boot. A light is mounted on the forward facing surface of the mirror housing. The light is oriented to project light in a forward direction generally opposite the direction faced by the open rear end of the housing.

Still another aspect of the invention is a method of mounting a light on an exterior side rear view mirror assembly. The method includes securing a mounting bracket to a forward facing surface of a rear view mirror housing of the mirror assembly. An electrical conductor that is connected to the light is extended through an opening made in the forward facing surface of the rear view mirror housing into the housing for connecting the light to a power source. A boot is positioned over the mounting bracket so a flexible back end of the boot conforms to and seals against the forward facing surface of the rear view mirror housing and covers the opening and a segment of the electrical conductor extending from the opening. The light is secured to the mounting bracket to fasten the light and boot to the forward facing surface of the rear view mirror housing.

Another aspect of the invention is a method of mounting two identical lights modules on two different vehicles. Each of the two vehicles has an exterior driver's side rear view mirror housing. The mirror housing of the first of the two vehicles has a forward facing surface that is substantially different in shape from the forward facing surface of the mirror housing of the second of the two vehicles. The method includes securing a mounting bracket to the forward facing surface of the rear view mirror housing for each of the two vehicles. For each of the two vehicles, electrical conductor that is connected to a light is extended through an opening made in the forward facing surface of the respective rear view mirror housing into the housing for connecting the light to a power source. For each of the two vehicles, a boot is positioned over the mounting bracket so a flexible back end of the boot conforms to and seals against the forward facing surface of the respective rear view mirror housing and covers the opening and a segment of the electrical conductor extending from the opening. For each of the two vehicles, the light and boot are secured to the mounting bracket to fasten the light and boot to the forward facing surface of the rear view mirror housing.

Yet another aspect of the invention is a light bar for displaying signal lighting on a vehicle. The light bar is adapted to be mounted on a top of the vehicle. The light bar includes a frame. A plurality of lights are mounted on the frame. A flexible boot is supported by the frame. The flexible boot is adapted to be compressed against the top of the vehicle to form a seal that blocks airflow between the lights and the top of the vehicle during movement of the vehicle.

Other objects and features will in part be apparent and will in part be pointed out hereinafter.

### BRIEF DESCRIPTION OF THE DRAWINGS

FIG. 1 is a perspective of one embodiment of a light module of the present invention;

FIG. 2 is a rear view of the light module illustrated in FIG. 1;

FIG. 3 is a top plan view of the light module illustrated in FIG. 1;

FIG. 4 is a bottom plan view of the light module illustrated in FIG. 1;

FIG. 5 is a perspective of the light module illustrated in FIG. 1 mounted on an exterior side rear view mirror assembly of a vehicle;

FIG. 6 is an exploded perspective of the light module and rear view mirror illustrated in FIG. 5;

FIG. 7 is a cross section of the light module illustrated in FIG. 1 taken in a plane including line 7-7 on FIG. 2;

FIGS. 8-12 illustrate a sequence in which the light module illustrated in FIG. 1 is mounted on a rear view mirror assembly as illustrated in FIG. 5;

FIG. 13 is a cross section taken in a plane including the longitudinal centerline of a light bar mounted on top of a vehicle illustrating another embodiment of the present invention; and

FIG. 14 is cross section of the light bar illustrated in FIG. 13 taken in a plane including the longitudinal centerline of the vehicle.

Corresponding reference characters indicate corresponding parts throughout the drawings.

### DETAILED DESCRIPTION

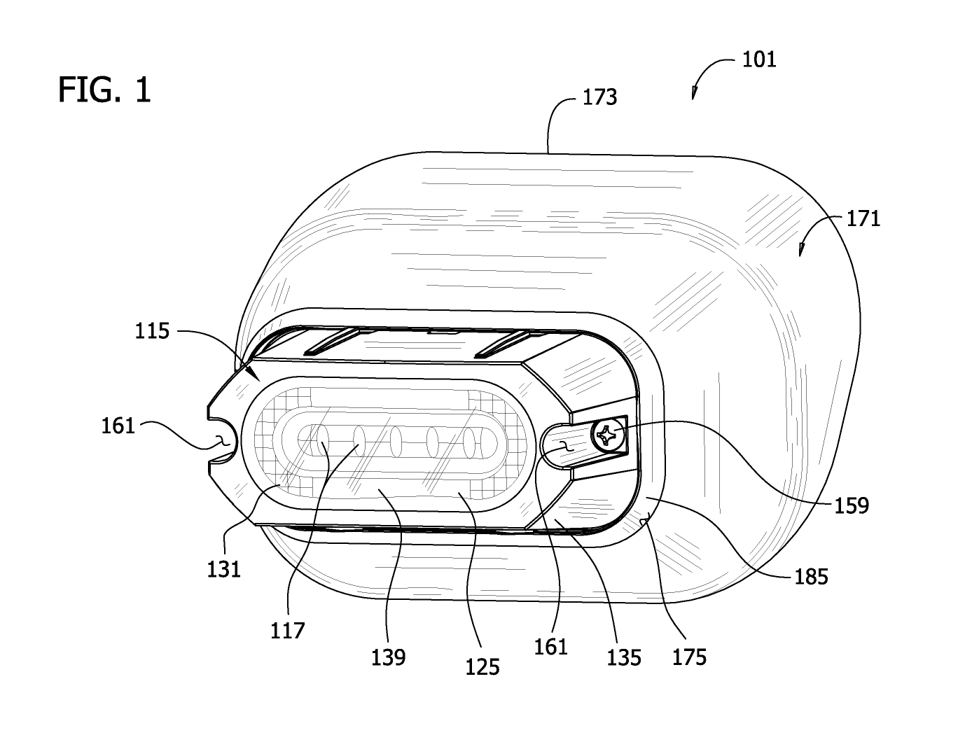

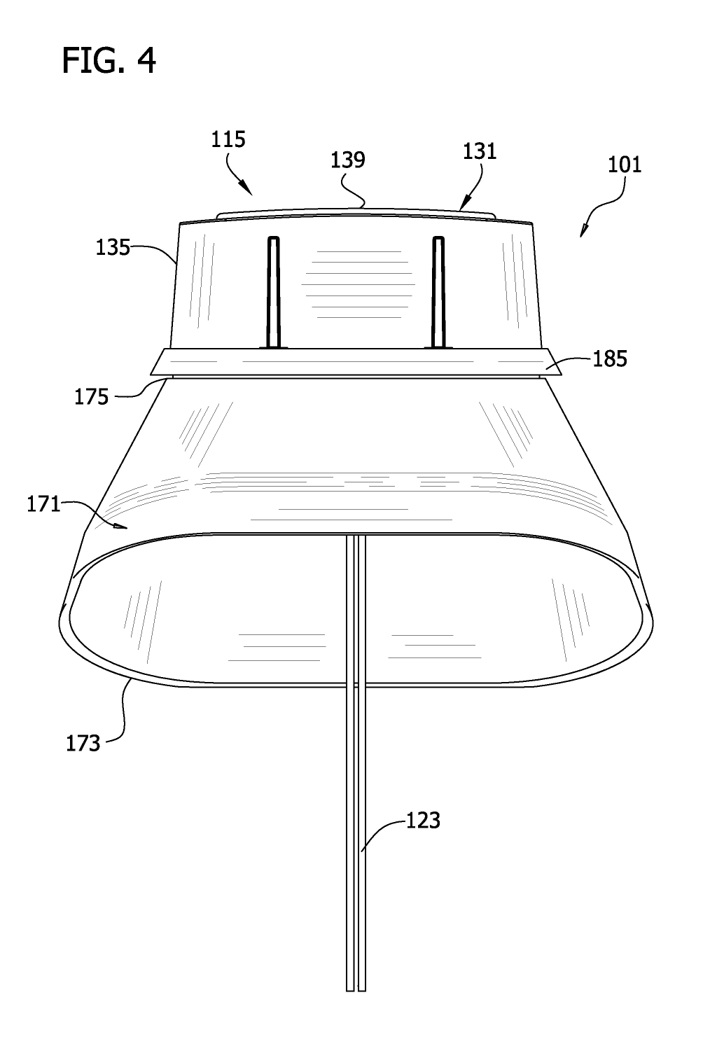

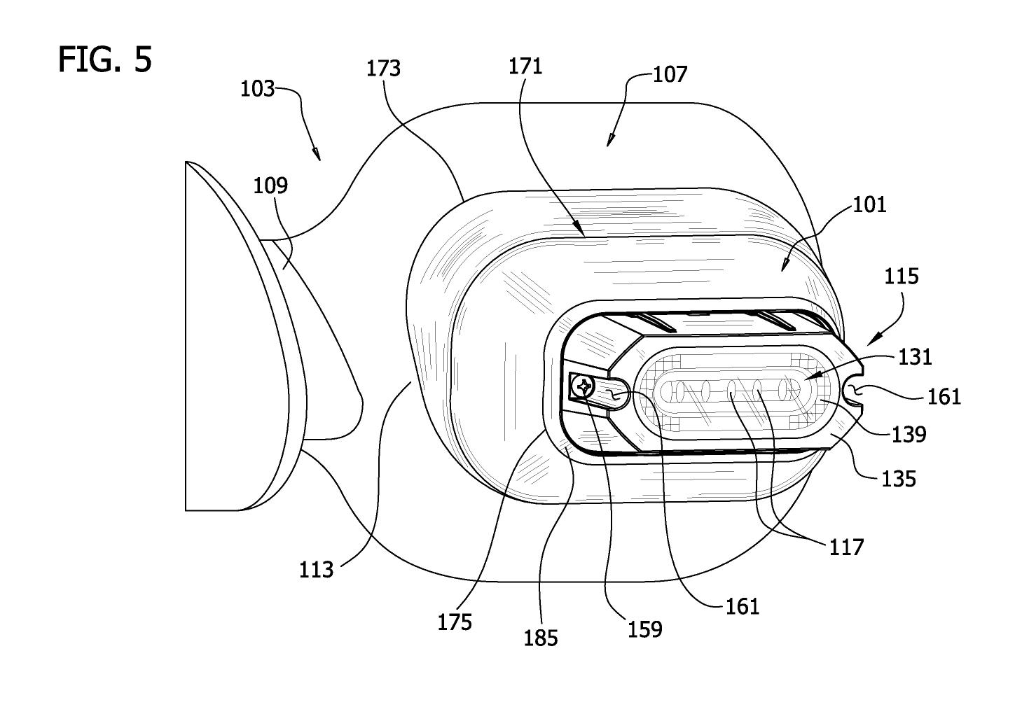

Referring to FIGS. 1-7, one embodiment of a light module, generally designated 101, is adapted to be mounted on a forward facing surface 113 of an exterior side rear view mirror assembly 103 of a vehicle as illustrated in FIG. 5.

The rear view mirror assembly 103 includes a mirror 105 and a housing 107 supported by an arm 109 extending laterally from the front passenger or driver side door (not shown) of a vehicle (e.g., car, truck, etc.). The housing 107 has an open end 111 and a forward facing surface 113 generally opposite the open end. The mirror 105 is secured to the housing 107 so a reflective surface of the mirror is visible from outside the housing. The light module 101 is adapted for interchangeable use with the side mounted external rear view mirror of a wide range of vehicles notwithstanding substantial variation in the size, shape and configuration of the mirror assemblies of different vehicle makes and models. Thus, the size, shape, and configuration of the mirror assembly can vary from what is illustrated in the drawings within the scope of the invention. The forward facing surface of the mirror assembly is typically curved and streamlined to reduce drag and is often contoured in a manner intended to complement contours of the vehicle body. The mirror housing 107 illustrated in the drawings is just one example of the type and shape of mirror housing that the module 101 can be mounted on.

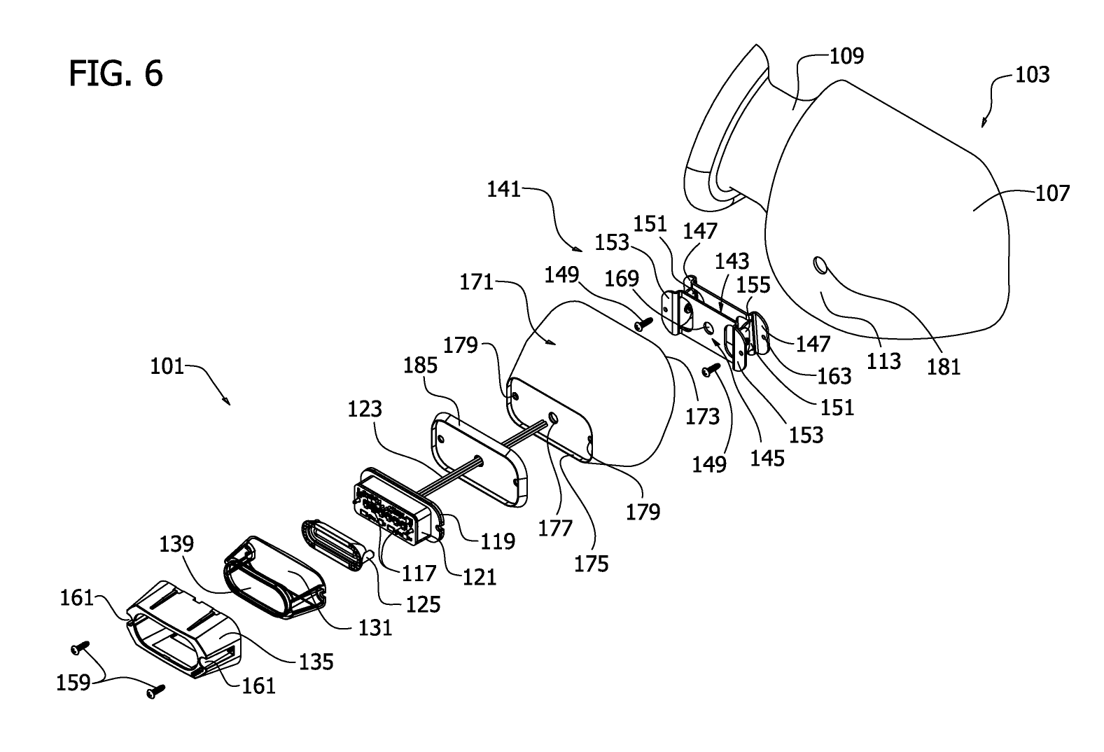

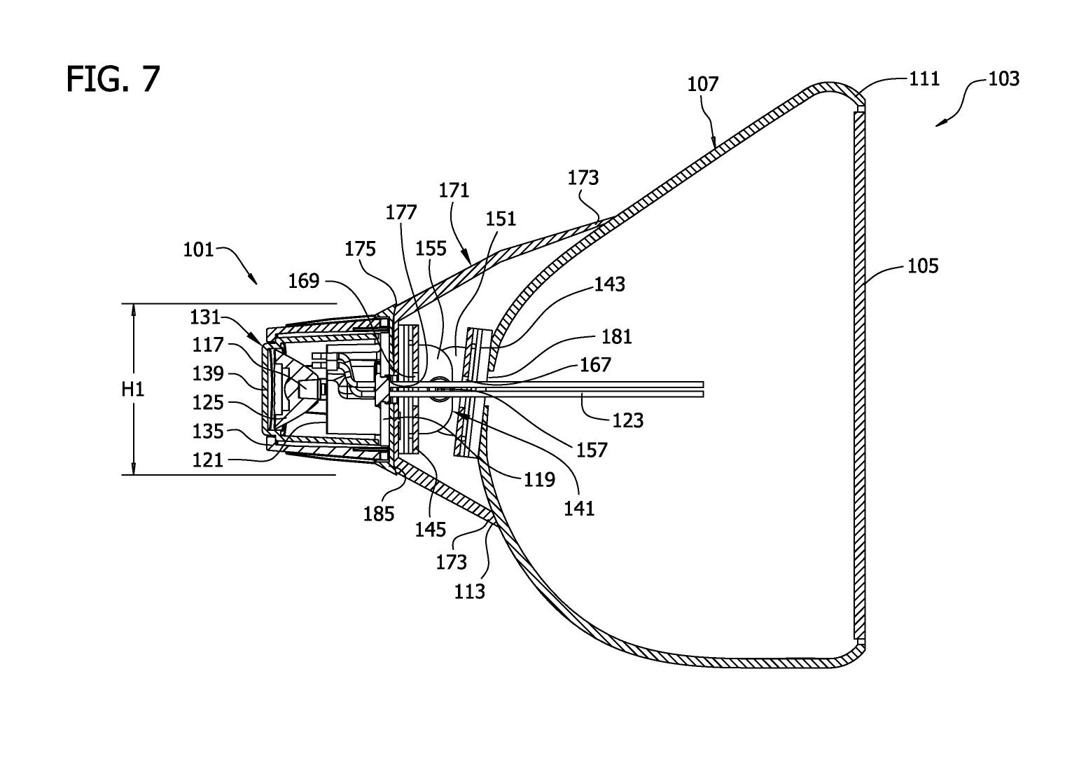

The module 101 includes a light head 115 containing one or more lights 117 (e.g., five LEDs in the embodiment shown in the drawings). For example, a suitable light head 115 includes a base 119 and a printed circuit board 121 supported by the base, as illustrated in FIGS. 6 and 7. The lights 117 are electrically connected to the printed circuit board 121 and are suitably mounted on the printed circuit board. At least one electrical conductor 123 extends through the base 119 and is connected to the printed circuit board 121 and lights 117 for providing power to the lights. As illustrated, for example, the at least one electrical conductor 123 includes a plurality of wires extending from the printed circuit board 121 through the light head base 119. A reflector 125 is suitably positioned (e.g., by being mounted on the printed circuit board 121) to reflect light from the lights 117 and increase the amount of light from each light that is projected in a forward direction along a beam axis, which can suitably have an orientation generally perpendicular to the printed circuit board 121 and base 119. The reflector can be any of various types of reflectors known to those skilled in the art, including without limitation a total internal reflector, a metalized plastic reflector, etc.

The light head 115 includes a cover 131 that cooperates with the light head base 119 to substantially enclose the reflector 125, lights 117, and printed circuit board 121 in the light head. The cover 131 is suitably made of a material that allows light from the lights 117 to pass through the cover. The cover 131 may include or be shaped to function as a lens, but this is not required. The cover 131 may be made of clear plastic or it may be a transparent plastic tinted with color. Likewise, the lights 109 may be adapted to emit light of any color. Further, various color combinations for the lights 117 and cover 131 may be selected to achieve a variety of different effects within the scope of the invention. To provide a few non-limiting examples, the light emitted from the module 101 may be any of the colors conventionally used in emergency signal lighting for police cars, fire trucks, or ambulances (e.g., various combinations of red, white, and/or blue). As another example, the light emitted from the module 101 may be amber or yellow as is conventional for many road construction or maintenance vehicles.

The light head 115 is suitably recessed or partially recessed within a bezel 135 that extends around a perimeter of the light head 115 and protects at least portions of the sides of the light head cover 131. The bezel 135 is suitably made of an opaque material (e.g., plastic) so the module 101 emits light only through the part of the cover 131 that is not obscured by the bezel. As illustrated, for example, the bezel 135 obstructs light passing through any part of the light head cover 131 except light passing through a generally flat forward facing surface 139 of the cover. The reflector 125 is positioned to direct the reflected light through the portion 139 of the light head cover 131 that is not obstructed by the bezel 135. Accordingly, the light module 101 is adapted to emit a beam of light from the forward facing surface 139 of the cover 131 along a beam axis 140 (FIG. 7). The beam axis 140 is suitably substantially perpendicular to the forward facing surface 139 of the cover 131.

The light module 101 includes a fastening system 141 adapted to mount the light head 115 and bezel 135 on the forward facing surface 113 of the housing 107 of the exterior mirror assembly 103. When mounted on the mirror housing 107, the light head 115 beam axis 140 suitably projects forward from the mirror assembly 103 in a direction generally opposite the open rear end 111 of the mirror housing, as illustrated in FIG. 7. The fastening system 141 suitably includes a mounting bracket 143 adapted to be mounted on the rear view mirror housing and a pivot bracket 145 adapted to mount the light on the mounting bracket. The pivot bracket 145 is suitably pivotally adjustable relative to the mounting bracket 143 for adjusting an angle at which the light is set relative to the forward facing surface 113 of the rear view mirror housing 107 during installation of the light module. The mounting bracket and pivot bracket can have numerous different configurations within the broad scope of the invention.

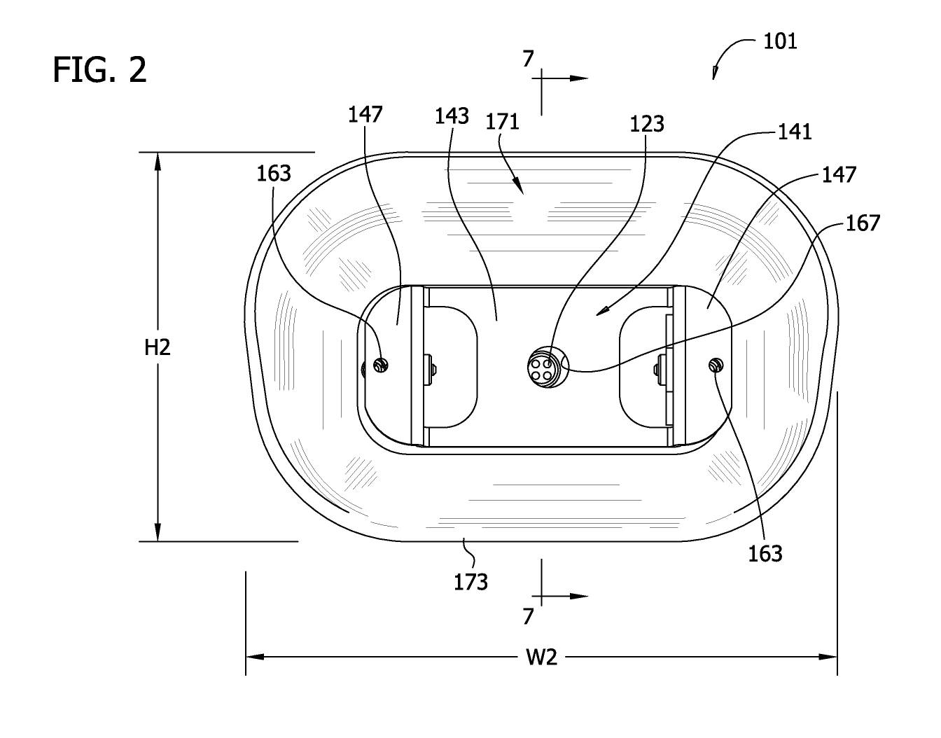

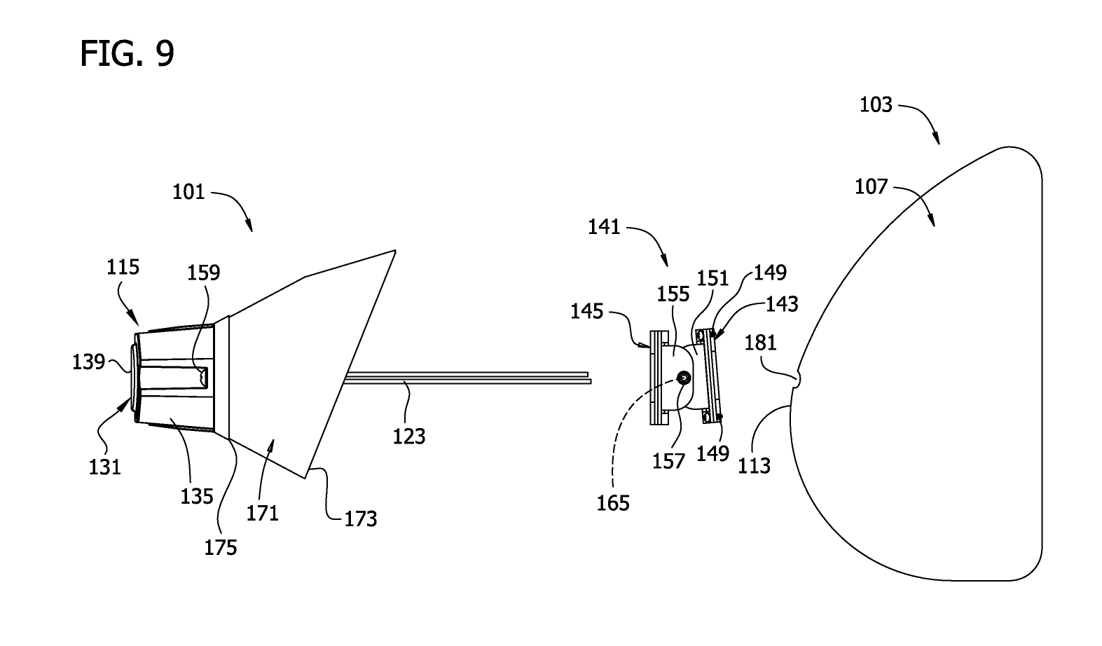

As illustrated, for example, the mounting bracket 143 has a pair of feet 147 on opposite sides of the mounting bracket. Each foot 147 is adapted to engage the forward facing surface 113 of the housing. The fastening system 141 also include fasteners 149 (e.g., screws) for securing the feet to the forward facing surface 113 of the mirror housing 107. For example, the mounting bracket 143 has a pair of openings 163 on opposite sides of the bracket (e.g., one opening extending through each foot 147) for receiving the fasteners 149. The mounting bracket 143 has a pair of arms 151 extending generally perpendicularly from the feet 147. There is a central opening 167 (FIGS. 2 and 7) in the mounting bracket between the feet 147 and also between the arms 151 thereof, the purpose of which will become apparent. The pivot bracket 145 is suitably substantially similar in construction to the mounting bracket 143. Thus, as illustrated in the drawings, the pivot bracket 145 has a pair of feet 153, arms 155, and a central opening 169 which are analogous to the feet 147, arms 151, and opening 167 of the mounting bracket 143, respectively. The fastening system 141 also includes fasteners 157 (e.g., screws) for securing the pivot bracket arms 155 to the mounting bracket arms 151, as illustrated in FIGS. 9-11. The fasteners 157 are also adapted to allow the pivot bracket 145 to rotate relative to mounting bracket 143 on a pivot axis 165 aligned with a line containing the fasteners in a first configuration of the fastening system (e.g., while the screws 157 are not tight) and resist rotation of the brackets relative to one another in a second configuration of the fastening system (e.g., while the screws 157 are tight). The pivot axis 165 is suitably substantially parallel to an imaginary line extending between the openings 163 for mounting the mounting bracket 143 on the mirror housing 107.

The fastening system also includes fasteners 159 (e.g., screws) for securing the bezel 135 to the pivot bracket 145. For example, the fasteners 159 of the illustrated embodiment secure the bezel 135 to the feet 153 of the pivot bracket 145. As illustrated in FIG. 6, grooves 161 are formed in the base 119, cover 131, and bezel 135 of the light head 115 on opposite sides thereof for receiving the fasteners 159. When bezel 135 is secured to the pivot bracket 145, the fasteners 159 are received in the grooves 161 and the light head 115 is retained in position between the pivot bracket 145 and bezel 135 and with the grooves 161 aligned with the fasteners. Thus, orientation of the pivot bracket 145 controls the orientation of the light head 115 and the beam axis 140 for the light emitted from the light head.

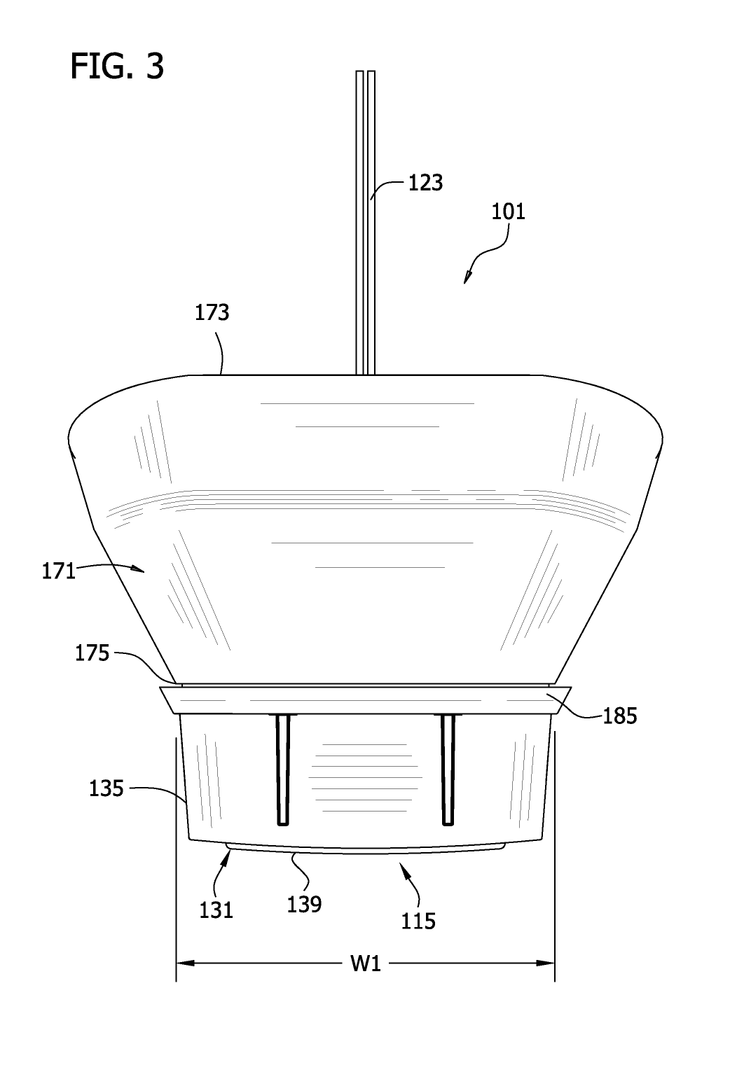

The light module 101 also includes a boot 171 adapted to be compressed against the forward facing surface 113 of the mirror housing 107 to form a seal against the mirror assembly 103. The boot 171 is tapered from a back end 173 to a front end 175 such that the front end has a width W1 (FIG. 3) that is narrower than the width W2 (FIG. 2) of the back end. At least the back end 173 of the boot 171 is suitably flexible to facilitate engagement of the back end of the boot with the forward facing surface 113 of the mirror housing 107 regardless of the make and model of the vehicle. For example, the entire boot 171 can suitably be made of a flexible elastomeric material. The front end 175 of the boot 171 has a pair of openings 179 (FIG. 6) on opposite sides thereof for receiving the fasteners 159 and being secured to the pivot bracket 145 along with the bezel 135 and light head 115. When the bezel 135, light head 115 and boot 171 are all secured to the pivot bracket 145, the front end 175 of the boot 171 is suitably positioned between the base 119 of the light head and the pivot bracket. Thus, the light head 115 is adapted to be mounted on the boot 171 opposite the back end 173 of the boot so the light head extends forward from the front end 175 of the boot. The front end 175 of the boot 171 suitably has an opening 177 so the conductor 123 can extend from the light head 115 into the boot through the opening.

The boot 171 and fastenings system 141 are configured so the fastening system presses the back end 173 of the boot against the forward facing surface of the housing 107 when the module 101 is mounted on the mirror assembly 103. For example, the fastening system 141 of the illustrated embodiment suitably holds the front end 175 of the boot 171 at a position spaced from the forward facing surface 113 of the mirror housing 107 a distance that is less than the distance between the front and back ends 175, 173 of the boot 171 and which requires the boot to resiliently deform so the back end of the boot is closer to the front end than it is in the un-deformed condition. The fastening system 141 and boot 171 cause the back end 173 of the boot to conform to any of a plurality of differently shaped forward facing mirror housing surfaces 113 to facilitate installation of the light module on any of a plurality of different vehicle makes and models. The boot 171 is suitably configured so a portion of the forward facing surface 113 of the mirror housing 107 is not covered by the boot when the module 101 is mounted on the mirror assembly 103. The boot 171 is also contoured so the contour of the light module 101 does not match the contour of the mirror housing 107. Thus, the light module 101, and the boot 171 in particular, are distinct in appearance from the mirror assembly 103. The back end 173 of the boot 171 in the illustrated embodiment is beveled so one side of the back end of the boot (e.g., the upper portion) is spaced farther from the front end 175 than the opposite side of the back end of the boot (e.g., the lower portion), as shown in FIG. 7. This can facilitate mounting the light module 101 on a mirror housing 107 having a sloped forward facing surface 113. However, the back end of the boot can have other configurations within the broad scope of the invention.

When the module 101 is mounted on the mirror assembly 103, a segment of the electrical conductor 123 extends from an opening 181 in the forward facing surface 113 of the mirror housing 107 and is substantially enclosed in the boot 171. The conductor 123 either extends through the mirror assembly 103 to connect to a power source (not shown) inside the vehicle or connects to another electrical conductor in the mirror assembly that is connected to such a power source so the power source can energize the lights 117 in the light module 101. The boot 171 conceals the conductor 123 and protects it from exposure to rain or other elements. In the illustrated embodiment a segment of the electrical conductor 123 extends from the light head 115 through the opening 177 at the front end 175 of the boot 171, into the boot, and then into the mirror housing 107 of the vehicle through the opening 181 made in the forward facing surface 113 thereof. However, the conductor 123 does not have to extend all the way through the boot 171. For example, a portion of the light head 115 can be positioned inside the boot 171 within the scope of the invention.

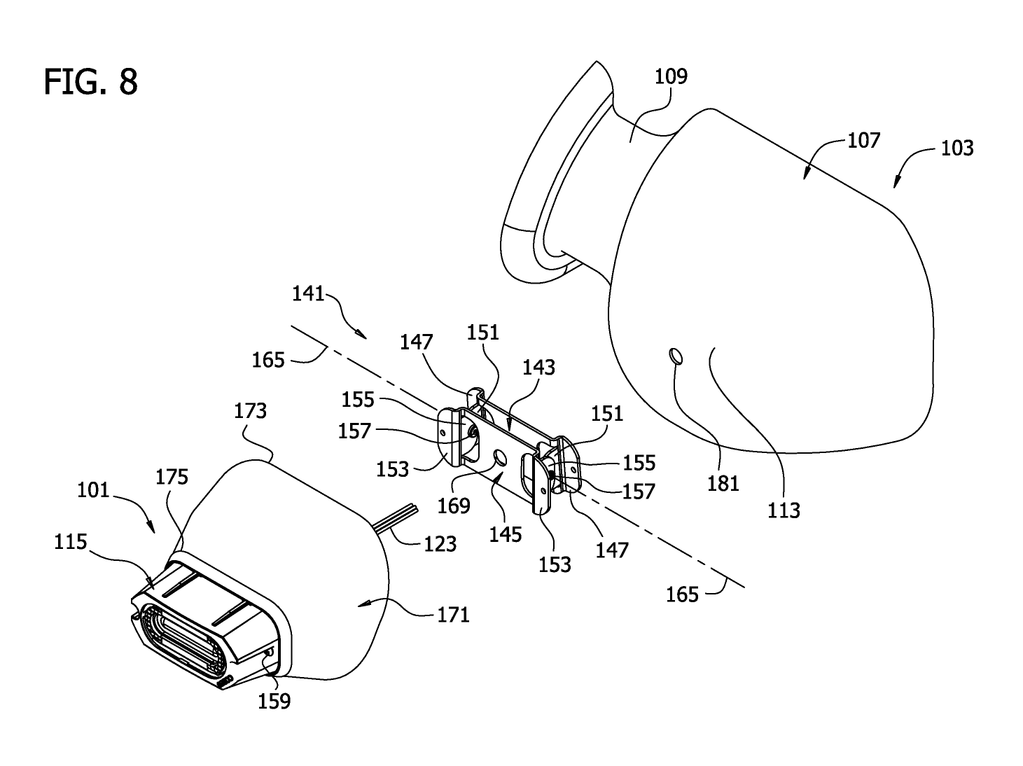

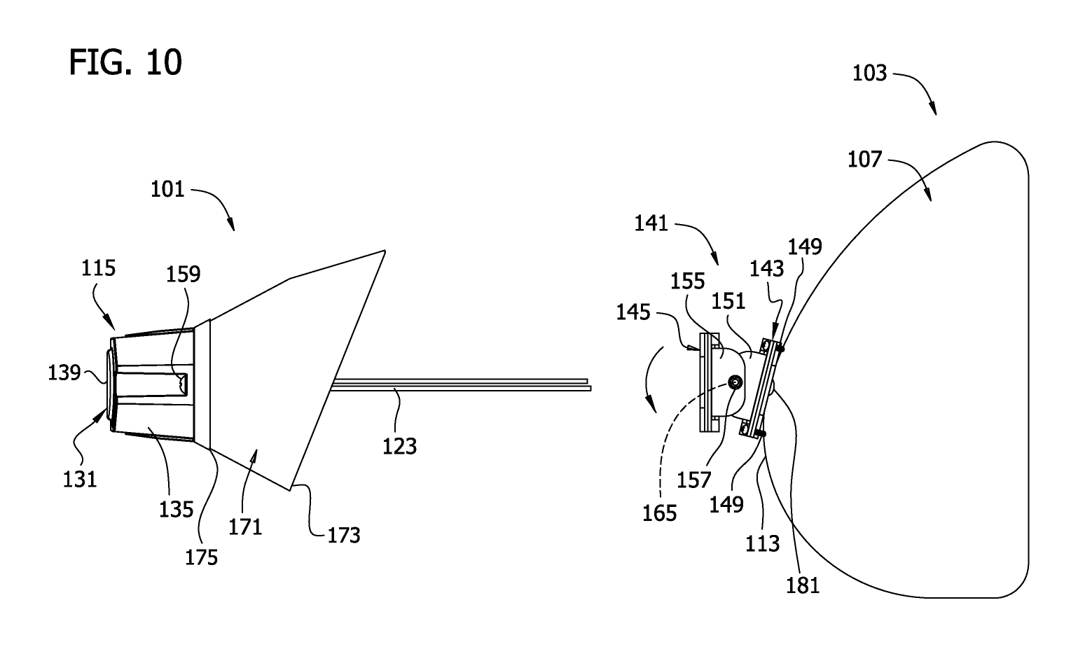

One embodiment of a method of mounting a light module 101 on the mirror assembly 103 of a vehicle will now be described with reference to FIGS. 8-12. An opening 181 is drilled or otherwise formed in the forward facing surface 113 of the mirror housing 107 to allow connection of the light module to the power source and other electronics (e.g., signal light control system) inside the vehicle. Then the mounting bracket 143 is positioned so its central opening 167 is generally aligned with the opening 181 in the mirror housing 107. The mounting bracket 143 is then secured to the mirror housing 107 in that position using the fasteners 149. The mounting bracket 143 is suitably secured to the mirror housing 107 in an orientation such that the openings 163 in the mounting bracket for the fasteners 147 are spaced generally horizontally from one another when the vehicle is parked on a flat horizontal surface. In this orientation, the arms 151 of the mounting bracket 143 are spaced generally horizontally from one another. If the pivot bracket 145 is not already connected to the mounting bracket 143, it is secured to the mounting bracket using the fasteners 157. If necessary, the pivot bracket 145 is pivoted on the pivot axis 165 (e.g., as indicated by the arrow in FIG. 10) to obtain a desired orientation of the pivot bracket and light head 115. For example, the orientation of the pivot bracket 145 is suitably adjusted so the engagement surfaces of its feet 153 are substantially vertical when the vehicle is on level ground. This results in the beam axis 140 of the light head 115 having a substantially horizontal orientation. If desired, the pivot bracket 145 can be adjusted to result in a different orientation of the light head 115 and beam axis 140 (e.g., angled slightly upward or slightly downward) without departing from the scope of the invention.

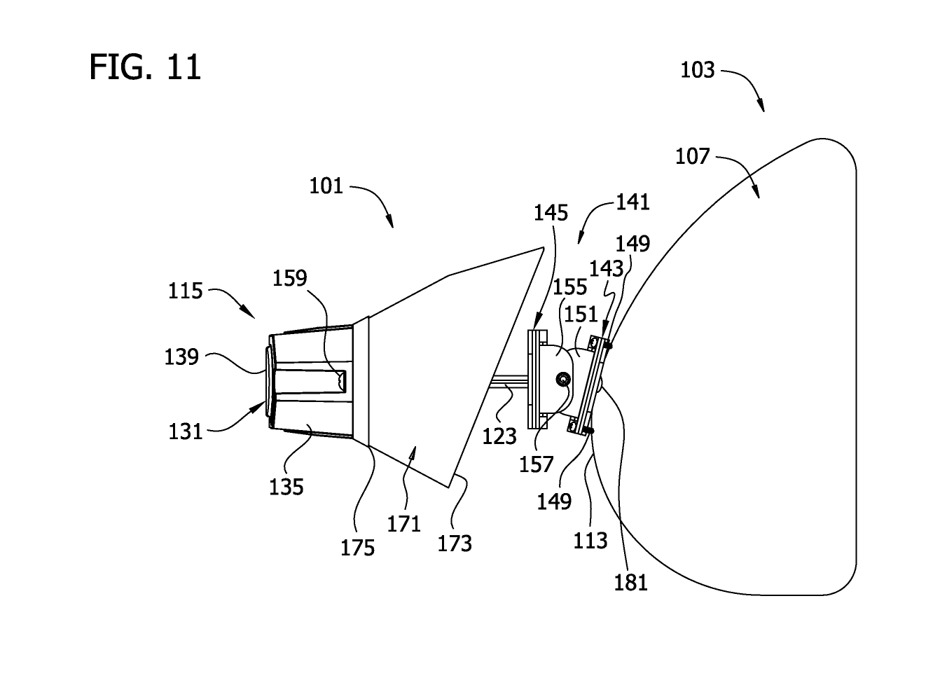

Once in the desired orientation, the pivot bracket 145 is suitably secured to the mounting bracket to limit the ability of the pivot bracket to pivot away from the desired orientation. The electrical conductors 123 are suitably extended through the openings 175, 169, 167 in the front end 173 of the boot, pivot bracket 145 and mounting bracket 143, respectively and into the mirror housing 107 through the opening 181 in the forward facing surface 113 thereof, as illustrated in FIG. 11. The conductors 123 are connected to a control system (not shown) inside the vehicle. For example, the conductors 123 can be routed through the arm 109 of the mirror assembly 103 and into the vehicle if needed. Alternatively, the conductors 123 can be connected to other conductors inside the mirror assembly 103 if there are any suitable conductors already provided in the mirror assembly.

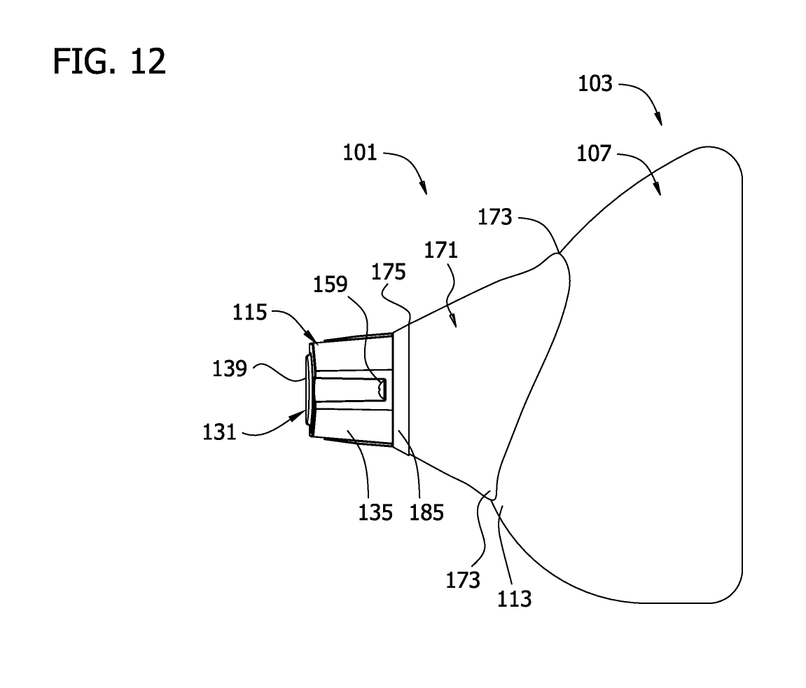

The fasteners 159 are used to secure the light head 115, base plate 185 and front end 175 of the boot 171 to the feet 153 of the pivot bracket 145 using the grooves 161 and openings 179 in the front end of the boot 171. As the boot 171 is secured to the fastening system 141, the back end 173 of the boot engages the forward facing surface of the mirror housing 107 and forms a seal against the mirror housing. As illustrated in FIG. 12, the boot 171 is deformed (e.g., compressed against the mirror housing) during this process. Thus, the shape of the boot 171 as installed on the mirror housing 107 is different from the shape of the boot before it is installed. For example, as illustrated in FIG. 12, the boot 171 is deformed (e.g., splayed outward) at its back end 173 and is shaped to achieve conformal engagement between the back end of the boot and the forward facing surface 113 of the mirror housing.

The process can be repeated to install another light module 101, which can be substantially identical to the light module described above, on the side rearview mirror assembly on the opposite side of the same vehicle.

If desired, the process of installing the light module on a rear view mirror assembly 103 can be repeated with a substantially identical light module 101 on a different vehicle (not shown) in which the forward facing surface of the mirror housing is substantially different in shape compared to the forward facing surface 113 of the mirror housing 107 illustrated in the drawings. Nevertheless, the beam axis 140 of the light head 115 for each light module can be positioned so it has same orientation (e.g., substantially horizontal and projecting forward) by making appropriate adjustments to the pivot brackets 145 during installation. Moreover, the back end 173 of each boot 171 suitably makes conformal contact with the forward facing surface of the respective mirror housing. The boots 171 of the two light modules 101 can be deformed differently from one another when installed due to the differences in the shape of the forward facing surfaces of the two mirror housings if necessary to achieve this result.

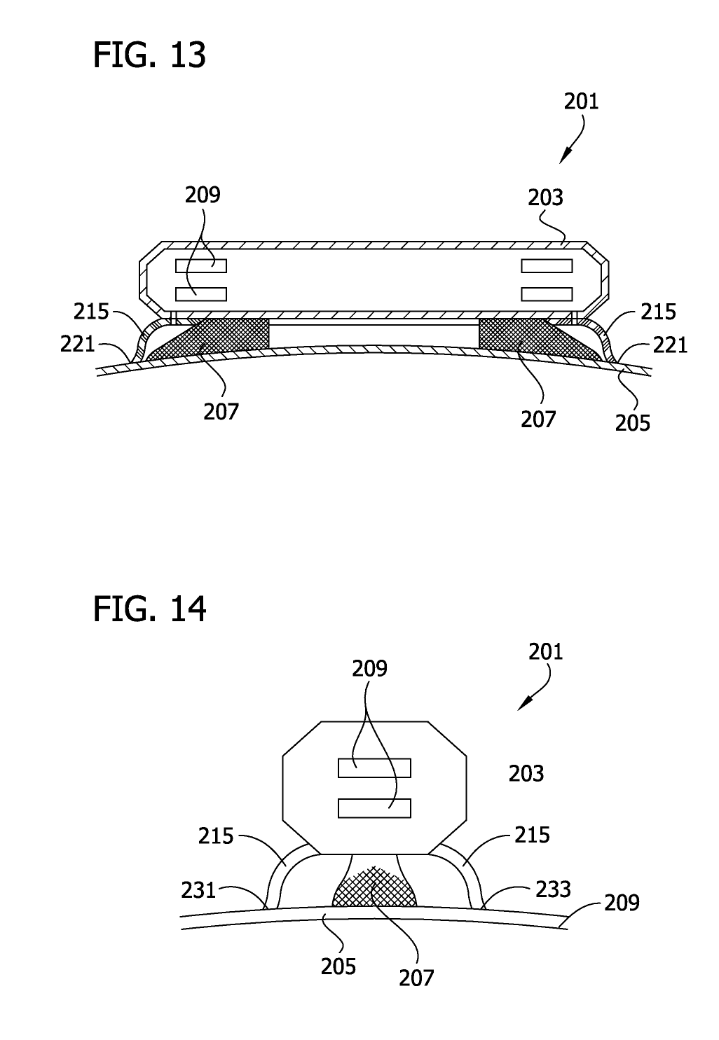

FIG. 13 illustrates another embodiment of a light module for the present invention, generally designated 201. This embodiment includes a light bar 203 adapted to be mounted on the top 205 (e.g., roof) of a vehicle. The light bar 203 includes a frame 207 and a plurality of lights 209 mounted on the frame. The construction of the light bar can vary widely within the scope of the invention and does not need to be described in detail because those skilled in the art will be familiar with many different suitable light bars for mounting on the top of a vehicle. The light module 201 also includes a boot 215 supported by the frame. At least a portion of the boot 215 is flexible and the boot is adapted to be compressed against the top 205 of the vehicle to form a seal that blocks airflow between the light bar 203 and the top of the vehicle during movement of the vehicle. The boot 215 suitably substantially encloses the frame 207 of the light bar 203 and forms a seal against the top of the vehicle extending all the way around the light bar. For instance, as illustrated in FIG. 14, the boot 215 suitably has a bottom end configured to engage and seal against the top 205 of the vehicle along a first line 231 extending transversely along the top of the vehicle and along a second line 233 extending transversely along the top of the vehicle, the first line being forward of the second line on the vehicle so at least a portion of the frame 207 (e.g., a mounting foot as illustrated) is positioned axially of the vehicle between the first and second lines. Because of the flexibility in the boot 215, the same style of boot can be used with many different makes and models of vehicle and with many different types of top mounted light bars. The boot 215 provides several advantages. For example, the boot 215 streamlines the appearance of the light bar 203 on the vehicle. The boot 215 also reduces drag on the vehicle when it is moving by blocking airflow in the space between portions of the light bar 203 and the top 205 of the vehicle. This improves gas mileage. The boot 215 also reduces turbulence and wind noise associated with the light bar 203 when the vehicle is moving.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “forward” and “rearward” and variations of these terms, or the use of other directional and orientation terms, is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

1. A light module for an exterior side mounted rear view mirror assembly of a vehicle, the rear view mirror assembly including a mirror and a housing, the housing having an open end and a forward facing surface generally opposite the open end, the mirror being secured to the housing so a reflective surface of the mirror is visible from outside the housing, the light module comprising:
a light;
an electrical conductor electrically connected to the light and adapted for connecting the light to a power source through an opening to be formed in the forward facing surface of the rear view mirror housing before installation of the light module thereon is complete;
a boot having an opening at a front end and a flexible back end; and
a fastening system adapted for mounting the light and boot on the forward facing surface of the rear view mirror housing so the flexible back end of the boot is compressed against the forward facing surface of the mirror housing and a segment of the electrical conductor extending from the opening in the forward facing surface of the rear view mirror housing is substantially enclosed in the boot when the light module is installed on the rear view mirror.

2. A light module as recited in claim 1 wherein the fastening system comprises a mounting bracket adapted to be mounted on the rear view mirror housing and a pivot bracket adapted to mount the light on the mounting bracket, the pivot bracket being pivotally adjustable relative to the mounting bracket for adjusting an angle at which the light is set relative to the forward facing surface of the rear view mirror housing during installation of the light module.

3. A light module as recited in claim 2 wherein the mounting bracket has a pair of openings on opposite sides of the mounting bracket for receiving fasteners adapted to secure the mounting bracket to the rear view mirror, the pivot bracket being pivotal relative to the mounting bracket about a pivot axis that is substantially parallel to a line extending between the openings on opposite sides of the mounting bracket.

4. A light module as recited in claim 1 wherein the boot is tapered from the flexible back end to the front end, the front end having a width narrower than a width of the flexible back end.

5. A light module as recited in claim 1 wherein the flexible back end of the boot is beveled so the distance between the flexible back end and the front end on one side of the boot is less than the distance between the flexible back end and the front end on an opposite side of the boot.

6. A light module for an exterior side rear view mirror assembly of a vehicle, the rear view mirror assembly including a mirror and a housing, the housing having an open end and a forward facing surface generally opposite the open end, the mirror being secured to the housing so a reflective surface of the mirror is visible from outside the housing, the light module comprising:
a light;
a flexible boot having a front opening and a back end opposite the front opening; and
a fastening system adapted for mounting the light source and boot on the forward facing surface of the rear view mirror housing,
the fastening system and boot being operable to cause the back end of the boot to conform to any of a plurality of differently shaped forward facing mirror housing surfaces to facilitate installation of the light module on any of a plurality of different vehicle makes and models.

7. A light module as recited in claim 6 wherein the fastening system comprises a mounting bracket adapted to be mounted on the rear view mirror housing and a pivot bracket adapted to mount the light on the mounting bracket, the pivot bracket being pivotally adjustable relative to the mounting bracket for adjusting an angle at which the light is set relative to the forward facing surface of the rear view mirror housing during installation of the light module.

8. A light module as recited in claim 6 wherein the light is in a light head and the light head is adapted to be mounted on the boot opposite the back end of the boot so the light head extends forward from the boot.

9. An exterior side rear view mirror assembly for a vehicle, the assembly comprising:
a housing having an open rear end and a forward facing surface opposite the opening;
a mirror secured to the housing so a reflective surface of the mirror is visible from outside the housing;
a boot having a front opening and a flexible back end, the flexible back end of the boot being compressed and sealed against the forward facing surface of the mirror housing, the back end of the boot being configured so at least a portion of the forward facing surface of the mirror housing is not covered by the boot; and
a light mounted on the forward facing surface of the mirror housing, the light being oriented to project light in a forward direction generally opposite the direction faced by the open rear end of the housing.

10. An exterior side rear view mirror assembly as set forth in claim 9 further comprising a fastening system mounting the light and boot on the forward facing surface of the rear view mirror housing, the fastening system comprising a mounting bracket mounted on the rear view mirror housing and a pivot bracket mounting the light on the mounting bracket, the pivot bracket having a pivot connection with mounting bracket for adjusting an angle at which the light is set relative to the forward facing surface of the rear view mirror housing during installation of the light module.

11. An exterior side rear view mirror assembly as set forth in claim 9 wherein the boot is tapered from the flexible back end to the front end, the front end having a width narrower than a width of the flexible back end, and the flexible back end of the boot is beveled so the distance between the flexible back end and the front end on one side of the boot is less than the distance between the flexible back end and the front end on an opposite side of the boot.

12. A method of mounting a light on an exterior side rear view mirror assembly, the method comprising:
securing a mounting bracket to a forward facing surface of a rear view mirror housing of the mirror assembly;
extending an electrical conductor for connecting the light to a power source through an opening made in the forward facing surface of the rear view mirror housing into the housing;
positioning a boot over the mounting bracket so a flexible back end of the boot conforms to and seals against the forward facing surface of the rear view mirror housing and covers the opening and a segment of the electrical conductor extending from the opening;
securing the light and boot to the mounting bracket to fasten the light and boot to the forward facing surface of the rear view mirror housing.

13. A method as set forth in claim 12 further comprising pivoting a pivot bracket mounted on the mounting bracket to adjust an orientation of the pivot bracket relative to the forward facing surface of the rear view mirror housing, wherein securing the light to the mounting bracket comprises securing the light to the pivot bracket.

14. A method as set forth in claim 13 further comprising securing the pivot bracket to the mounting bracket in an orientation selected so the light will be oriented to direct a beam of light in a generally horizontal direction after the light is secured to the pivot bracket.

15. A method of mounting two identical lights modules on two different vehicles, each of the two vehicles having an exterior driver's side rear view mirror housing, the mirror housing of the first of the two vehicles having a forward facing surface that is substantially different in shape from a forward facing surface of the mirror housing of the second of the two vehicles, the method comprising:
securing a mounting bracket to the forward facing surface of the rear view mirror housing for each of the two vehicles;
for each of the two vehicles, extending an electrical conductor for connecting the light to a power source through an opening made in the forward facing surface of the respective rear view mirror housing into the housing;
for each of the two vehicles, positioning a boot over the mounting bracket so a flexible back end of the boot conforms to and seals against the forward facing surface of the respective rear view mirror housing and covers the opening and a segment of the electrical conductor extending from the opening; and
for each of the two vehicles, securing the light and boot to the mounting bracket to fasten the light and boot to the forward facing surface of the rear view mirror housing.

16. A method as recited in claim 15 wherein for each of the two vehicles, securing the light to the mounting bracket comprises securing the light to a pivot bracket supported by the mounting bracket, the method further comprising pivoting the pivot bracket relative to the mounting bracket so the light will have a desired orientation relative to the vehicle after the light is secured to the mounting bracket.

17. A method as recited in claim 16 wherein for each of the two vehicles, securing the light to the mounting bracket comprises pivoting the pivot bracket relative to the mounting bracket so the light will be oriented to project a beam of light in a substantially horizontal direction when it is secured to the mounting bracket.

18. A light bar for displaying signal lighting on a vehicle, the light bar being adapted to be mounted on a top of the vehicle, the light bar comprising:
a frame;
a plurality of lights mounted on the frame; and
a flexible boot supported by the frame, the flexible boot being adapted to be compressed against the top of the vehicle to form a seal that blocks airflow between the lights and the top of the vehicle during movement of the vehicle.

19. A light bar as set forth in claim 18 wherein the boot is configured to substantially enclose the frame when the light bar is mounted on the vehicle.

20. A light bar as set forth in claim 18 wherein the flexible boot has a bottom end configured to engage and seal against the top of the vehicle along a first line extending transversely along the top of the vehicle and along a second line extending transversely of the vehicle, the first line being forward of the second line on the vehicle, at least a portion of the frame being positioned axially of the vehicle between the first and second lines.
